(19) United States
(12) Patent Application Publication
(10) Pub. No.: US 2021/0356272 A1
(43) Pub. Date: Nov. 18, 2021

(54) METHOD FOR OPERATING A MICROELECTROMECHANICAL GYROSCOPE, AND GYROSCOPE

(71) Applicant: Robert Bosch GmbH, Stuttgart (DE)

(72) Inventors: Manuel Dietrich, Reutlingen (DE); Wolfgang Schmid, Burladingen (DE)

(21) Appl. No.: 17/313,400

(22) Filed: May 6, 2021

(30) Foreign Application Priority Data
May 13, 2020 (DE) 102020206003.7

(51) Int. Cl. G01C 19/5712; G01C 25/00

(52) U.S. Cl. CPC G01C 19/5712; G01C 25/005

(57) ABSTRACT

A method for operating a microelectromechanical gyroscope. In an operating mode of the gyroscope, the mass is driven in a pulsed manner, and in coordination therewith, measured values are read out by cyclically repeating: a. a start-up phase in which a drive circuit of the gyroscope is activated and operated until a mass of the gyroscope carries out a defined oscillating movement at a predefined first target amplitude, b. a measuring phase in which the drive circuit is operated in such a way that the defined oscillating movement of the mass is maintained, and is detected in the measured values and read out by a readout circuit of the gyroscope, and c. rest phase in which the drive circuit is at least partially deactivated, the duration of the rest phase being selected in such a way that the amplitude of the oscillating movement of the mass does not drop to zero.

### CROSS REFERENCE

The present application claims the benefit under 35 U.S.C. § 119 of German Patent Application No. DE 102020206003.7 filed on May 13, 2020, which is expressly incorporated herein by reference in its entirety.

### FIELD

The present invention is directed to a method for operating a gyroscope, and a gyroscope.

### BACKGROUND INFORMATION

Microelectromechanical systems (MEMS) are used as sensors in numerous applications. For example, rotational movements may be measured using MEMS gyroscopes. For detecting rotational movements, MEMS gyroscopes require actively moved masses which transform a rotational movement that is present into a resulting, detectable Coriolis force. The controlled excitation of this movement requires electrical energy, which represents a majority of the total current consumption of the sensor. In conventional methods, the objective is typically to hold an oscillation amplitude of the moved mass constant during operation of the sensor. Times of up to 100 ms are required for achieving a constant, stable target oscillation amplitude. Only then are stable rotation rate signals available.

### SUMMARY

An object of the present invention is to provide a method for operating a gyroscope, and a gyroscope, which allow energy-saving and/or cost-effective operation.

The method according to an example embodiment of the present invention for operating a gyroscope may have the advantage over the related art that a pulsed operating mode is achievable in which the drive circuit may be temporarily deactivated, at least partially, during use of the gyroscope, so that the current consumption of the drive circuit or drive control of the system drops. At the same time, the energy consumption may be kept low during the transient oscillation of the mass to a first target amplitude, since during operation, the MEMS generally does not have to be newly excited from a rest position. This may be achieved according to an example embodiment of the present invention by selecting the duration of the rest phase in such a way that the drive circuit is reactivated before the amplitude of the oscillating movement of the mass has dropped to zero, i.e., before the mass has come to rest. This results overall in a particularly power-saving method for operating the gyroscope, it being possible at the same time to carry out precise measurements.

According to an example embodiment the present invention, it is possible in particular that during a start-up phase (a.) the drive circuit is activated until the mass carries out a defined oscillating movement at a predefined first target amplitude. In addition, during a measuring phase (b.) the drive circuit is preferably activated in such a way that the drive circuit delivers an electrical drive signal via which the oscillating mass is excited into an oscillating movement at the first target amplitude. During the rest phase (c.), the drive circuit is preferably at least partially deactivated in such a way that the electrical drive signal is not output, and the oscillating mass is correspondingly not driven. After the electrical drive signal is shut off, the amplitude of the oscillation of the mass decreases as a function of the quality of the mass oscillation. For high quality, the amplitude decreases only comparatively slowly. Since no electrical drive signal is output by the drive circuit, according to the present invention current is advantageously saved. Before the amplitude of the oscillating movement of the mass drops to zero (i.e., before the oscillation has completely died down), the rest phase ends and the drive circuit is reactivated, so that the drive circuit once again delivers an electrical drive signal via which the oscillating mass is driven. Power and time may thus be saved when the amplitude is once again increased to the first target amplitude, since the mass does not have to be excited from its rest position or a static position, and instead still carries out a residual oscillation.

According to an example embodiment of the present invention, a particularly energy-efficient method may thus be provided which offers advantages over methods in which only portions of a path are temporarily switched off for measuring the rotation rate signals, but the drive continues to be held at a constant target amplitude.

In addition, the method according to an example embodiment of the present invention may offer advantages over methods in which duty cycling is used, in which the drive movement in the rest phases comes to a standstill. In such methods, the mass would have to be periodically started from a standstill, which disadvantageously results in long cycle times, very low repetition rates, and increased current consumption upon each particular increase of the oscillation amplitude from the rest position. According to the present invention, the drive circuit may instead be reactivated before the amplitude of the oscillating movement of the mass has dropped to zero.

Advantageous embodiments and refinements of the present invention are derivable from the description herein with reference to the figures.

According to one preferred refinement of the present invention, it is provided that the duration of the rest phase is selected in such a way that the amplitude of the oscillating movement of the mass dies down at most up to a predefined amplitude threshold value greater than zero. The amplitude threshold value may be understood in particular to mean a residual oscillation amplitude to which the amplitude drops to a minimum at the end of the rest phase. It is preferably possible for the amplitude threshold value to be predefinable by a selection of the duration of the rest phase. This is particularly advantageous when the quality of the system or the die-down behavior of the oscillating movement is known. However, it is alternatively or additionally possible for the amplitude threshold value to be directly determinable, and ascertainable via measurements, for example.

For example, it is preferably possible for the amplitude threshold value or the residual oscillation amplitude to correspond to a value between and including 20% and 80% of the first target amplitude. The amplitude threshold value is in particular a function of the design of the gyroscope, the quality of the oscillator, the electrical properties of the MEMS, the target amplitude, the performance of the drive circuit with regard to feeding energy into the drive movement, etc.

According to one preferred refinement of the present invention, it is provided that at least the duration of the individual phases a., b., and c. and/or the first target amplitude and/or control parameters for controlling the oscillating movement of the mass and/or filter parameters for reading out the measured values are/is predefined in the form of a parameter set for the drive circuit and/or the readout circuit.

According to one preferred refinement of the present invention, it is provided that multiple operating modes using a mass that is driven in a pulsed manner are achievable by selecting different parameter sets for the drive circuit and/or the readout circuit.

According to one preferred refinement of the present invention, it is provided that at least the duration of the individual phases a., b., and/or c. and/or the first target amplitude and/or control parameters for controlling the oscillating movement and/or filter parameters for reading out the measured values are/is automatically optimized with regard to a lowest possible current consumption and a sought quality of the measured values. The duration of the rest phase, with low current consumption in relation to the active time windows, is preferably on the one hand optimized in such a way that the temporally integrated total current consumption is as low as possible. On the other hand, the ratio is preferably to be selected in such a way that the residual amplitude of the mass after the rest phase (or at the end of the rest phase), i.e., the amplitude threshold value, is still as high as possible in order to keep the required start-up phase as short as possible. It is particularly preferably possible for an automatic optimization of the individual phases a., b., and/or c. and/or of the first target amplitude and/or of control parameters for controlling the oscillating movement and/or of filter parameters for reading out the measured values to take place during operation of the gyroscope, and not at the factory during fabrication of the gyroscope. Flexible adaptation and optimization are possible in this way.

According to one preferred refinement of the present invention, it is provided that at least during the measuring phase, measured values, in particular concerning a rotational movement and/or a rotation rate, are measured. An advantageous measurement may thus take place while the mass is oscillating at its fixed, preferably selectable, first target amplitude. Precise measurements may be carried out as the result of such constant measuring conditions. A detection means (i.e., a detector), in particular a Coriolis and/or rotation rate detection means (i.e., a Coliolis detector and/or rotation rate detector), is provided in or at the gyroscope for detecting the measured data. A signal of the detection means is preferably provided to a readout circuit, a measuring device, or a measuring unit.

According to one preferred refinement of the present invention, it is provided that at least in start-up phase a. and/or in rest phase c., measured values are detected, and read out and weighted by the readout circuit, the weighting of the measured values taking place based on the ratio of the instantaneous amplitude to the first target amplitude. It is thus possible for measured values to be detected, in particular before and/or after the measuring phase, in particular while the mass is not yet or no longer oscillating at the first target amplitude. Similarly, it is advantageously possible for the duration of the measuring phase to be reducible over the entire cycle, as the result of which energy may be saved in a particularly advantageous manner. However, since the measured values during start-up phase a. and/or rest phase c. are recorded at an amplitude that does not correspond to the first target amplitude, the measured values recorded in the start-up phase and/or rest phase are preferably subjected to weighting and/or scaling. It is possible, for example, for the weighting to be carried out in such a way that measured values are weighted less with an increasingly greater distance of the instantaneous amplitude (at which a measured value is recorded) from the first target amplitude. Thus, measured values that are ascertained at the first target amplitude may be weighted higher than measured values that are recorded at a distance from the first target amplitude.

According to one preferred refinement of the present invention, it is provided that measured values are detected, and read out and weighted by the readout circuit, only during a predefined time interval within start-up phase a. and/or during a further predefined time interval within rest phase c. A time window may thus be determined in which measured values are ascertained during the start-up phase and/or rest phase. The situation in particular that measured values are ascertained at an instantaneous oscillation amplitude that is too low may thus be advantageously prevented.

According to one preferred refinement of the present invention, it is provided that at least in start-up phase a. and/or in rest phase c., a check is made as to whether the instantaneous amplitude is greater than a predefined minimum amplitude value, and measured values are detected, and read out and weighted by the readout circuit, only when the instantaneous amplitude is greater than the predefinable minimum amplitude value.

According to one preferred refinement of the present invention, it is provided that broadband filters with short runtimes and high output frequencies are utilized when reading out the measured values, so that at least one filtered measured value is available for each cycle of the operating mode using a mass that is driven in a pulsed manner.

According to one preferred refinement of the present invention, it is provided that the read-out measured values are further processed, average values being formed over a predefinable number of measured values in each case, and/or a standard deviation of the measured values from an average value being determined.

According to one preferred refinement of the present invention, it is provided that the gyroscope is selectively operated in at least one operating mode using a mass that is driven in a pulsed manner, or in at least one further operating mode using a continuously driven mass, in this further operating mode a defined oscillating movement of the mass at a predefined second target amplitude being maintained, at least at defined time intervals. During the continuous operating mode, the mass is preferably continually and/or continuously driven with the aid of the drive circuit and held at the second target amplitude, in particular without the drive circuit being temporarily switched off during the continuous operating mode.

According to one preferred refinement of the present invention, it is provided that in the at least one operating mode using a mass that is driven in a pulsed manner and in the at least one further operating mode using a continuously driven mass, different parameter sets are used for the drive circuit and/or for the readout circuit.

According to one preferred refinement of the present invention, it is provided that the same amplitude value or different amplitude values is/are selected for the first target amplitude in the operating mode using a mass that is driven in a pulsed manner, and for the second target amplitude in the further operating mode using a continuously driven mass. According to one specific embodiment of the present invention, it may be possible in particular for the first target amplitude in the pulsed operating mode to be different from the second target amplitude in the continuous operating mode. This results in a change in the resulting Coriolis force at constant rotation. In this case, the data path must allow the output signal to be adapted to the modified input sensitivity. For this purpose, appropriate configurability and switchability may be provided by a digital logic system. Similarly, different parameter sets are particularly preferably used for the drive circuit and/or for the readout circuit for the different operating modes.

According to one preferred refinement of the present invention, it is provided that switching between different operating modes takes place initiated by the user or automatically, based on events. A change may thus be flexibly made between a pulsed operating mode and a continuous operating mode.

A further subject matter of the present invention relates to a gyroscope. In accordance with an example embodiment of the present invention, the gyroscope includes

at least one mass that is excitable into oscillations for detecting measured values, at least one drive circuit for exciting and maintaining an oscillating movement of the mass, and at least one readout circuit for the detected measured values; characterized by at least one operating mode in which the mass is driven in a pulsed manner and measured values are read out in coordination with same by cyclically repeating the following phases:

a. a start-up phase in which the drive circuit is activated and operated until the mass carries out a defined oscillating movement at a predefined first target amplitude,

b. a measuring phase in which the drive circuit is operated in such a way that the defined oscillating movement of the mass is maintained, and is detected in the measured values and read out by the readout circuit, and

c. a rest phase in which the drive circuit is at least partially deactivated, the duration of the rest phase being selected in such a way that the amplitude of the oscillating movement of the mass does not drop to zero.

According to one preferred refinement of the present invention, it is provided that the drive circuit and/or the readout circuit are/is reconfigurable, so that in a selective manner at least one operating mode using a mass that is driven in a pulsed manner is achievable, and/or at least one further operating mode using a continuously driven mass is achievable in which a defined oscillating movement of the mass at a predefined second target amplitude is maintained, at least at defined time intervals.

According to one preferred refinement of the present invention, it is provided that an operating mode control unit that controls the switching between different operating modes and provides a parameter set to the drive circuit and/or to the readout circuit for the particular selected operating mode predefines at least the duration of the individual phases a., b., and c. for a mass that is driven in a pulsed manner and/or the target amplitude and/or control parameters for controlling the oscillating movement and/or filter parameters for reading out the measured values.

According to one preferred refinement of the present invention, it is provided that the gyroscope includes at least one memory unit in which at least one parameter set for configuring the drive circuit and/or the readout circuit is storable. It is possible for the memory unit to be part of a user device in which the gyroscope is installed, and/or for the memory unit to be part of the gyroscope or to be explicitly associated with the gyroscope. At least one continuous operating mode and one or multiple pulsed operating modes are preferably supported, it being possible to change between the various operating modes with the aid of different parameter sets for the drive circuit and/or readout circuit. Such different parameter sets may advantageously be stored in the memory unit.

The features, specific embodiments, and advantages that have already been described in conjunction with the method according to the present invention for operating a gyroscope, or described in conjunction with a refinement of the method, may be applied to the gyroscope.

Exemplary embodiments of the present invention are illustrated in the figures and explained in greater detail below.

### BRIEF DESCRIPTION OF THE DRAWINGS

FIG. 1 shows a schematic illustration of a method according to one specific example embodiment of the present invention.

FIG. 2 shows a schematic illustration of a system according to one specific example embodiment of the present invention.

### DETAILED DESCRIPTION OF EXAMPLE EMBODIMENTS

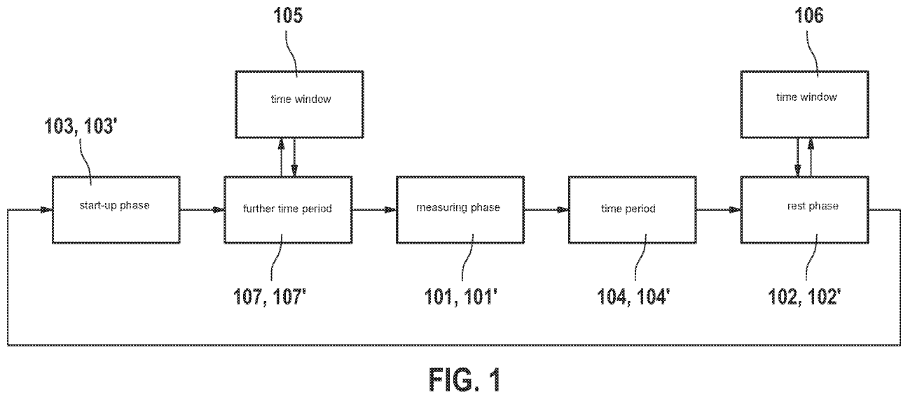

FIG. 1 shows a schematic illustration of a method for operating a microelectromechanical gyroscope according to one specific example embodiment of the present invention. The illustrated specific embodiment includes a measuring phase 101, a rest phase 102, a start-up phase 103, and a time period 104 and a further time period 107.

Microelectromechanical system 1 or the gyroscope includes an oscillating mass 2 that may be excited into an oscillating movement with the aid of a drive circuit 3′. During measuring phase 101, drive circuit 3′ is activated in such a way that drive circuit 3′ delivers an electrical drive signal via which oscillating mass 2 is excited into an oscillation at a first target amplitude. Similarly, mass 2 oscillates at the first target amplitude in measuring phase 101. A rotation rate measurement is carried out and measured values of the gyroscope are ascertained during measuring phase 101. For this purpose, the gyroscope includes a detection means 6, in particular a Coriolis and/or rotation rate detection means. Via the number of measured rotation rate samples and the setting of filters 7, the mode may be optimized between a low current consumption due to a short measuring period on the one hand, and the quality of the measured data (noise, for example) on the other hand. Either the measured data are provided directly, or the transition into the optional postprocessing time window takes place (transition to time period 104). Time period 104, i.e., the postprocessing of the measured values, may be designed as part of the measuring phase and/or of the rest phase. The current consumption during measuring phase 101 is comparatively high, since oscillating mass 2 is held at the first target amplitude.

After measuring phase 101, drive circuit 3′ is at least partially deactivated, and during rest phase 102 remains at least partially deactivated in such a way that during rest phase 102, the electrical drive signal is not output by drive circuit 3′ and oscillating mass 2 is correspondingly not driven. As a result, the oscillation amplitude of mass 2 decreases during rest phase 102 corresponding to a quality of the mass oscillation. With high quality the amplitude decreases only slowly. The length of rest phase 102 may advantageously be optimized in such a way that rest phase 102 on the one hand makes up a large portion of the cycle, but on the other hand a sufficient residual oscillation amplitude is still present in order to shorten subsequent start-up phase 103. Current consumption during rest phase 102 is very low. The optimization of the duration of rest phase 102 in interaction with the other time windows of the overall cycle may take place via a self-optimization of the duration of the phases (and in particular of rest phase 102), using a corresponding logic system. Alternatively or additionally, an optimization may be carried out beforehand based on experiments or simulations.

At the end of rest phase 102, the amplitude of the oscillation of oscillating mass 2 has dropped to a residual amplitude or an amplitude threshold value. However, mass 2 is still oscillating and is not at rest. Before the amplitude of the oscillation of mass 2 falls to zero, i.e., has completely died down, at the end of rest phase 102 drive circuit 3′ is reactivated, in particular when the amplitude threshold value is reached, in such a way that drive circuit 3′ once again delivers an electrical drive signal via which oscillating mass 2 is driven.

At the beginning of start-up phase 103, drive mass 2 of gyroscope 1 is therefore still oscillating, but with an amplitude that is smaller than the first target amplitude. Drive circuit 3′ is reactivated, using a controller parameter set that is specifically optimized to the pulsed operating mode, in order to increase the oscillation amplitude to the first target amplitude and to stabilize it there. The current consumption in start-up phase 103 is comparatively high.

Further time period 107 preferably begins as soon as a monitor 3 of drive circuit 3′ signals that the first target amplitude will soon be reached. The state of the individual control elements is now closely monitored. If monitor 3 reports stable operation at the first target amplitude, the transition to measuring phase 101 takes place. An optimization between the duration of the time period and the quality of the amplitude stability takes place via the selection of the monitoring parameters. The current consumption in further time period 107 continues to be comparatively high, but drops slightly compared to residual start-up phase 103, since the required drive power is already falling. Further time period 107 may also be understood as a part of start-up phase 103.

Time period 104 is optionally provided between measuring phase 101 and the rest phase, and/or as part of measuring phase 101 and/or of rest phase 102. During time period 104, an output of the measured values of the gyroscope may be adapted with the aid of a postprocessing device 8. For example, the average value of the measured values may be ascertained and output here, or corrections of the measured value or measured values may be made. The transition to rest phase 102 may in particular also already take place at the start of time period 104 (parallel start of rest phase 102 and time period 104). The current consumption may thus already be reduced to a comparatively low level, as in rest phase 102. Time period 104 may also be understood as a part of rest phase 102.

Time periods or phases 101, 102, 103, 104, 107 may be cyclically or periodically repeated, so that a pulsed operating mode is achieved. In particular, during a further pass, i.e., in a further cycle, a further measuring phase 101′, a further rest phase 102′, a further start-up phase 103′, and optionally an additional further time period 107′ and optionally an additional time period 104′ are run through.

In addition to the pulsed operating mode, which includes phases and time periods 101, 102, 103, and optionally 107, 104, the system may also be operated in a continuous operating mode. In the continuous operating mode, oscillating mass 2 is excited into continuous oscillation at a second target amplitude with the aid of drive unit 3′. The second target amplitude of the continuous operating mode may be different from the first target amplitude in measuring phase 101 of the pulsed operating mode, or alternatively may correspond to the first target amplitude. Time windows 105, 106 represent by way of example the transition from the rest position of mass 2 (during a start of the measuring process) or from the continuous operating mode into the pulsed operating mode (or vice versa). The change into the cycle of the pulsed operating mode may take place at various locations, depending on the previous state of moved mass 2. If mass 2 or the drive is at rest, a start from the rest position is preferably carried out in time window 105, using the control parameters necessary for this purpose. The change into the cycle of the pulsed operating mode takes place in further time period 107, for example. If the drive or mass 2 is already deflected (due to the fact that the system has previously been operated in the continuous operating mode), according to time window 106 a change into the cycle of the pulsed operating mode in rest phase 102 is appropriate. The change between the continuous operating mode and the pulsed operating mode may take place initiated by the user, automatically, and/or based on events.

The total cycle duration is preferably optimizable also during an adaptation of the individual phases to a constant value, in order to allow application 11 to be provided with rotation rate measured values at a constant output frequency, if this is necessary.

Circuit parts that are not needed are preferably deactivated in phases and time periods 101, 102, 103, 104, 107 in order to further reduce the total current consumption. For example, the function blocks of measuring device 5, of filter 7, and of postprocessing device 8 are deactivated, at least partially, during start-up phase 103 and optionally further time period 107 if they are not needed.

Depending on the application, various parameter sets and cycle settings may be stored and run through. For example, the total cycle time may have a changeable or switchable design by adapting the individual phases or time periods. For this purpose, multiple parameter sets for the drive circuit and/or readout circuit, which may be selected as needed, are preferably stored in a memory unit 9 or setting unit. Thus, for example, the total cycle duration may be switched from 40 ms (25 Hz) to 20 ms (50 Hz), even during use of the gyroscope, if this is necessary for application 11 or some other application. In another case, for example with a higher total current consumption, the portion of measuring phase 101 may be extended in order to improve the measuring quality.

The loading of the parameter sets, the drive controller, the monitoring of the control elements, the control of the various phases and/or time periods, the postprocessing of the measured data, as well as all other steps that are necessary for the running of the cycle and the activation and deactivation of the cycle may preferably take place using an integrated circuit (ASIC), a programmable logic system (FPGA), a microcontroller, and/or an external host application 11. Subtasks may also be controlled by various platforms, for example in a combination of an ASIC and a microcontroller.

In the case that mass 2 is in the rest position at the start, the control of the drive movement of mass 2 is typically designed in such a way that the resting sensor element is brought as quickly as possible to target amplitude. The controller coefficients of the drive controller are optimized accordingly. For a residual movement that still exists, the starting may thus result in an instability of the controller, or even in excitation of parasitic movement patterns in the MEMS element. Therefore, to ensure a stable operation for the various operating modes, continuous and pulsed drive, with the aid of drive circuit 2′, preferably on the one hand the drive controller is so broadly configurable that both working points may be covered, and on the other hand, a switch between the operating modes of the drive controller is made possible by loading a parameter set that is appropriate in each case. The appropriate parameter sets may preferably be stored in a memory unit 9 in the sensor and/or in an external memory unit 9 in such a way that they may be retrieved. A switch may preferably be made between various parameter sets via a digital logic system. This may take place using a microcontroller, for example.

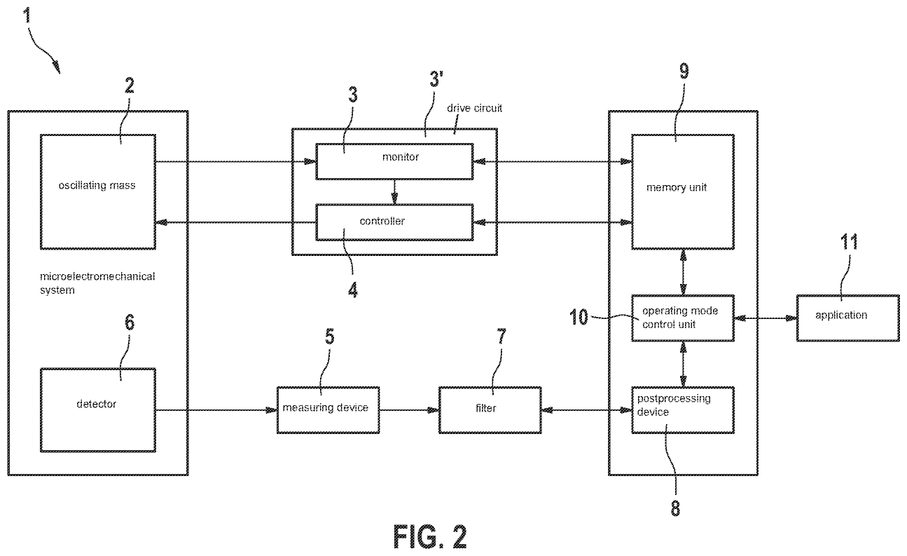

FIG. 2 shows a schematic illustration of a system according to one specific embodiment of the present invention. The system includes a microelectromechanical system 1 designed as a gyroscope, including an oscillating mass 2, in particular a drive mass. The gyroscope also includes a detection means 6, in particular a Coriolis and/or rotation rate detection means. Measured values, in particular concerning a rotational movement and/or a rotation rate, may be ascertained or measured with the aid of detection means 6. A signal of detection means 6 is provided to a readout circuit 5 or measuring device. Readout circuit 5 provides the measured values to a filter 7 or multiple filters. Broadband filters 7 with short runtimes and high output frequencies are preferably utilized for reading out the measured values, so that at least one filtered measured value is available for each cycle of the pulsed operating mode. In addition, the system may include a postprocessing device 8. The read-out measured values may be further processed with the aid of postprocessing device 8, in particular average values being formed over a predefinable number of measured values in each case, and/or a standard deviation of the measured values from an average value being determined. The system also includes a memory unit 9 for the drive control or drive circuit 3′. With the aid of memory unit 9 and stored parameter sets, drive circuit 3′ may be configured in such a way that the oscillation excitation of the desired operating mode may be set. Drive circuit 3′ may thus be set, for example corresponding to phases 101, 102, 103 (and optionally 104 and/or 107), for a pulsed operating mode with the aid of such parameter sets. Furthermore, an operating mode control unit 10 including a communication unit is provided. A change from the pulsed operating mode into the continuous operating mode, or from the continuous operating mode into the pulsed operating mode, may be carried out with the aid of operating mode control unit 10. In addition, a change may be made between different pulsed operating modes, for example having different durations of the individual phases, with the aid of memory unit 9 and/or operating mode control unit 10.

Correspondingly different parameter sets are used for the different pulsed operating modes. In addition, a host application 11 is illustrated which may request the rotation rate measurements and/or which is provided with the rotation rate measured values. Oscillating mass 2 is excited and operated with the aid of drive circuit 3′. Drive circuit 3′ includes in particular a monitor 3 for monitoring/detecting the oscillation of mass 2, and a controller 4 for controlling the drive of mass 2.

What is claimed is:

1. A method for operating a microelectromechanical gyroscope, the gyroscope including at least one mass that is excitable into oscillations for detecting measured values, at least one drive circuit configured to excite and maintain an oscillating movement of the mass, and including at least one readout circuit for the detected measured values, the method comprising:
in at least one operating mode of the gyroscope, driving the mass in a pulsed manner, and in coordination therewith, reading out the measured values by cyclically repeating the following phases:
a. a start-up phase including activating and operating the drive circuit until the mass carries out a defined oscillating movement at a predefined first target amplitude,
b. a measuring phase including operating the drive circuit in such a way that the defined oscillating movement of the mass is maintained, and is detected in the measured values and read out by the readout circuit, and
c. a rest phase including at least partially deactivating the drive circuit, a duration of the rest phase being selected in such a way that an amplitude of the oscillating movement of the mass does not drop to zero.

2. The method as recited in claim 1, wherein the duration of the rest phase is selected in such a way that the amplitude of the oscillating movement of the mass dies down at most up to a predefined amplitude threshold value greater than zero.

3. The method as recited in claim 1, wherein at least: (i) a duration of each of the start-up phase, the measuring phase, and the rest phase, and/or (ii) the first target amplitude, and/or (iii) control parameters for controlling the oscillating movement of the mass, and/or (iv)filter parameters for reading out the measured values, are predefined in the form of a parameter set for the drive circuit and/or the readout circuit.

4. The method as recited in claim 3, wherein multiple operating modes of the gyroscope using the mass that is driven in the pulsed manner are achievable by selecting different parameter sets for the drive circuit and/or the readout circuit.

5. The method as recited in claim 1, wherein at least: (i) a duration of each of the start-up phase, and/or the measuring phase, and/or the rest phase, and/or (ii) the first target amplitude, and/or (iii) control parameters for controlling the oscillating movement, and/or (iv) filter parameters for reading out the measured values, are automatically optimized with regard to a lowest possible current consumption and a sought quality of the measured values.

6. The method as recited in claim 1, wherein at least in the start-up phase and/or in the rest phase, the measured values are detected, and read out and weighted by the readout circuit, the weighting of the measured values taking place based on a ratio of an instantaneous amplitude to the first target amplitude.

7. The method as recited in claim 6, wherein the measured values are detected, and read out and weighted by the readout circuit, only during a predefined time interval within the start-up phase and/or during a further predefined time interval within the rest phase.

8. The method as recited in claim 6, wherein at least in the start-up phase and/or in the rest phase, a check is made as to whether the instantaneous amplitude is greater than a predefined minimum amplitude value, and the measured values are detected, and read out and weighted by the readout circuit, only when the instantaneous amplitude is greater than the predefined minimum amplitude value.

9. The method as recited in claim 1, wherein broadband filters with short runtimes and high output frequencies are utilized when reading out the measured values, so that at least one filtered measured value is available for each cycle of the operating mode using the mass that is driven in the pulsed manner.

10. The method as recited in claim 1, wherein the read-out measured values are further processed, average values being formed over a predefinable number of measured values in each case, and/or a standard deviation of the measured values from an average value being determined.

11. The method as recited in claim 1, wherein the gyroscope is selectively operated in the at least one operating mode using the mass that is driven in the pulsed manner, or in at least one further operating mode using a continuously driven mass, and wherein in the further operating mode a second defined oscillating movement of the mass at a predefined second target amplitude is maintained, at least at defined time intervals.

12. The method as recited in claim 11, wherein in the at least one operating mode using a mass that is driven in the pulsed manner and in the at least one further operating mode using the continuously driven mass, different parameter sets are used for the drive circuit and/or for the readout circuit.

13. The method as recited in claim 11, wherein the same amplitude value or different amplitude values is selected for the first target amplitude in the at least one operating mode using the mass that is driven in the pulsed manner, and for the second target amplitude in the further operating mode using a continuously driven mass.

14. The method as recited in claim 11, wherein switching between different operating modes takes place initiated by a user or automatically, based on events.

15. A gyroscope, comprising:
at least one mass that is excitable into oscillations for detecting measured values;
at least one drive circuit configured to excite and maintaining an oscillating movement of the mass; and
at least one readout circuit for the detected measured values;
wherein the gyroscope is configured in such a way that it has at least one operating mode in which the mass is driven in a pulsed manner and the measured values are read out in coordination therewith by cyclically repeating the following phases:
a. a start-up phase in which the drive circuit is activated and operated until the mass carries out a defined oscillating movement at a predefined first target amplitude,
b. a measuring phase in which the drive circuit is operated in such a way that the defined oscillating movement of the mass is maintained, and is detected in the measured values and read out by the readout circuit, and
c. a rest phase in which the drive circuit is at least partially deactivated, a duration of the rest phase being selected in such a way that an amplitude of the oscillating movement of the mass does not drop to zero.

16. The gyroscope as recited in claim 15, wherein the drive circuit and/or the readout circuit is reconfigurable, so that in a selective manner, the at least one operating mode using the mass that is driven in the pulsed manner is achievable, and/or at least one further operating mode using a continuously driven mass is achievable in which a second defined oscillating movement of the mass at a predefined second target amplitude is maintained, at least at defined time intervals.

17. The gyroscope as recited in claim 16, further comprising:
an operating mode control unit configured to control switching between different operating modes and provides a parameter set to the drive circuit and/or to the readout circuit for the selected operating mode, and that predefines at least: a duration of each of the start-up phase, the measuring phase, and the rest phase for the mass that is driven in a pulsed manner and/or the target amplitude and/or control parameters for controlling the oscillating movement and/or filter parameters for reading out the measured values.

18. The gyroscope as recited in claim 16, further comprising:
at least one memory unit in which at least one parameter set for configuring the drive circuit and/or the readout circuit is stored.
